(19) United States
(12) Patent Application Publication
(10) Pub. No.: US 2013/0329908 A1
(43) Pub. Date: Dec. 12, 2013

(54) ADJUSTING AUDIO BEAMFORMING SETTINGS BASED ON SYSTEM STATE

(71) Applicants: Aram Mcleod Lindahl, Menlo Park, CA (US); Ronald Isaac, San Ramon, CA (US)

(72) Inventors: Aram Mcleod Lindahl, Menlo Park, CA (US); Ronald Isaac, San Ramon, CA (US)

(73) Assignee: Apple Inc., Cupertino, CA (US)

(21) Appl. No.: 13/607,568

(22) Filed: Sep. 7, 2012

Related U.S. Application Data
(60) Provisional application No. 61/657,624, filed on Jun. 8, 2012.

(51) Int. Cl. H04R 3/00

(52) U.S. Cl. 381/92

(57) ABSTRACT

Audio beamforming is a technique in which sounds received from two or more microphones are combined to isolate a sound from background noise. A variety of audio beamforming spatial patterns exist. The patterns can be fixed or adapted over time, and can even vary by frequency. The different patterns can achieve varying levels of success for different types of sounds. To improve the performance of audio beamforming, a system can select a mode beam pattern based on a detected running application and/or device settings. The system can use the mode beam pattern to configure an audio beamforming algorithm. The configured audio beamforming algorithm can be used to generate processed the audio data from multiple audio signals. The system can then send processed audio data to the running application.

### CROSS REFERENCE TO RELATED APPLICATIONS

This application claims the benefit of U.S. Provisional Patent Application No. 61/657,624, entitled “ADJUSTING AUDIO BEAMFORMING SETTINGS BASED ON SYSTEM STATE,” filed on Jun. 8, 2012, which is incorporated herein by reference in its entirety.

### BACKGROUND

1. Technical Field

The present disclosure relates to audio beamforming and, more specifically, to adjusting audio beamforming settings based on system state.

2. Introduction

Many applications running on computing devices involve functionality that requires audio input. Unfortunately under typical environmental conditions, a single microphone may do a poor job of capturing a sound of interest due to the presence of various background sounds. To address this issue many computing devices often rely on noise reduction, suppression, and/or cancellation techniques. One commonly used technique to improve signal to noise ratio is audio beamforming.

Audio beamforming is a technique in which sounds received from two or more microphones are combined to enable the preferential capture of sound coming from certain directions. A computing device that uses audio beamforming can include an array of two or more closely spaced, omnidirectional microphones linked to a processor. The processor can then combine the signals captured by the different microphones to generate a single output to isolate a sound from background noise. For example, in delay sum beamforming each microphone receives the sound signal independently and the received sound signals are summed to determine the sound's directional angle. The maximum output amplitude is achieved when the signal originates from a source perpendicular to the array. That is, when the sound source is perpendicular to the array, the signals all arrive at the same time and are therefore highly correlated. However, if the sound source is non-perpendicular to the array, the signals will arrive at different times and will therefore be less correlated, which will result in a lesser output amplitude. The output amplitude of various sounds makes it possible to identify background sounds that are arriving from a direction different from the direction of the sound of interest.

A variety of different microphone shapes exist and each shape has different noise reduction capabilities. Therefore, a variety of audio beamforming spatial response patterns exist. The patterns can be fixed or adapted over time, and can even vary by frequency. However, the different patterns achieve varying levels of success for different types of sound, which can lead to suboptimal results.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for configuring audio beamforming settings based on system state. An audio beamforming algorithm can have a number of different settings, including a mode and/or a beam pattern. To improve noise reduction results, an audio beamforming algorithm can be configured based on a current state of a computing device. To configure the audio beamforming settings, the computing system can detect a predetermined actively running application, such as a dictation application, a speech recognition application, an audio communications application, a video chat application, an audio recording application, or a music playback application. Additionally, in some cases, the system can detect at least one predetermined device setting, such as fan speed, current audio route, or a configuration of microphone and speaker placement.

Based on the detected application and/or device setting, the system can select a mode beam pattern. The mode beam pattern can specify a mode, such as fixed or adaptive. Additionally, the mode beam pattern can specify a beam pattern, such as omnidirectional, cardioid, hyper-cardioid, sub-cardioid, or figure eight. The system can use the mode beam pattern to configure an audio beamforming algorithm. For example, a beamformer can load a mode and/or beam pattern based on the values specified in the mode beam pattern. After configuring the beamforming algorithm, the system can process audio data received from an array microphone using the beamforming algorithm. The system can send the processed data to the running application. In some embodiments, prior to sending the processed data to the running application, the system can apply a noise suppression algorithm. In some cases, the noise suppression algorithm can also be configured based on the detected running application and/or at least one predetermined device setting.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an examplary system embodiment;

FIG. 2 illustrates an exemplary computing device with an array of microphones;

FIG. 3 illustrates exemplary spatial response patterns;

FIG. 4 illustrates an exemplary audio beamformer configuration process;

FIG. 5 illustrates four exemplary representations of system information;

FIG. 6 illustrates an exemplary hybrid fixed-adaptive beam pattern scenario; and

FIG. 7 illustrates an exemplary method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

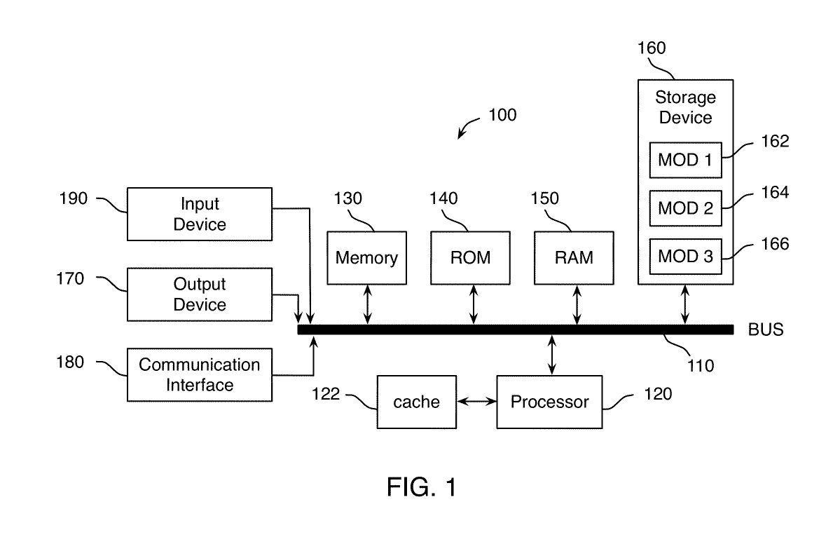

The present disclosure addresses the need in the art for improved audio signal processing to isolate a sound from background noise. Using the present technology it is possible to improve noise reduction results by adjusting an audio beamforming algorithm based on one or more attribute values of a computing device. The disclosure first sets forth a discussion of a basic general-purpose system or computing device in FIG. 1 that can be employed to practice the concepts disclosed herein before returning to a more detailed description of audio beamforming.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, output device 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. In some cases, the microphone can be an array of microphones. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

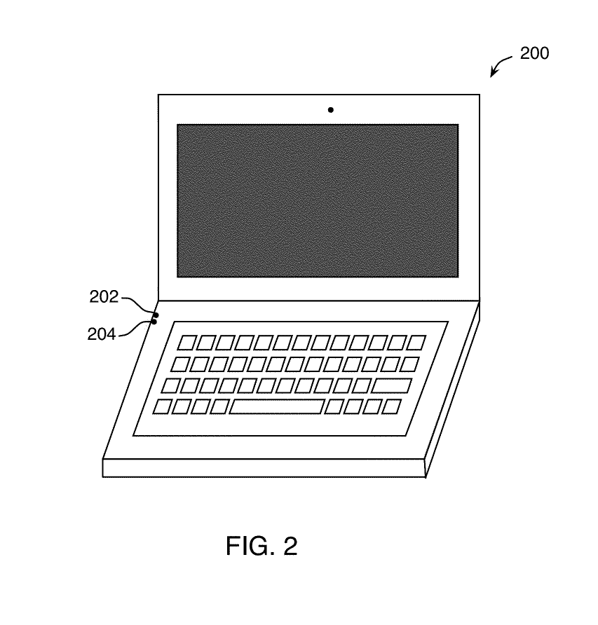

Before disclosing a detailed description of the present technology, the disclosure turns to a brief introductory description of how an audio signal is processed using audio beamforming. Audio beamforming is a technique in which sounds received from two or more microphones are combined to enable the preferential capture of sound coming from certain directions. A computing device that uses audio beamforming can include an array of two or more omnidirectional microphones linked to a processor. For example, FIG. 2 illustrates an exemplary computing system 200 with an array of two microphones 202 and 204, such as a general-purpose computing device like system 100 in FIG. 1. The number, spacing, and/or placement of microphones in the microphone array can vary with the configuration of the computing device. In some cases, a greater number of microphones can provide more accurate spatial noise reduction. However, a greater number of microphones can also increase the processing cost. While a mobile computing device is depicted in FIG. 2, audio beamforming can be used on any computing device that includes a microphone array, such as a desktop computer; mobile computer; handheld communications device, e.g. mobile phone, smart phone, tablet; smart television; set-top box; and/or any other computing device equipped with an array of microphones. Additionally, a microphone array can be configured such that only a subset of the microphones are active. That is, a subset of the microphones can be disabled, for example, when accuracy is not as important and the cost of processing is high.

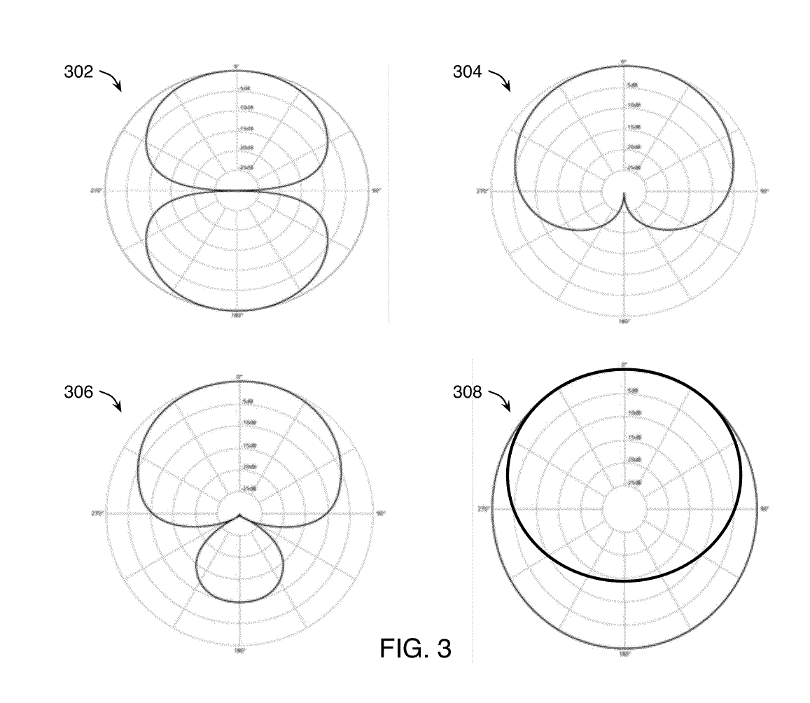

As described above, the microphones can be omnidirectional. However, a variety of different microphone shapes exist and each shape can have different noise reduction capabilities based on noise direction. For example, different shapes can be used to reduce noise coming from specific directions. To leverage the advantages of different microphone shapes, spatial response or beam patterns can be applied to the microphones to create virtual microphones. For example, FIG. 3 illustrates four possible spatial response patterns: figure eight 302, cardioid 304, hyper-cardioid 306, and sub-cardioid 308. In each of graphs 302, 304, 306, and 308, the outer ring represents the gain at each beam direction for an omnidirectional microphone. The inner shape represents the gain at each direction when the corresponding pattern is applied. For example, graph 302 represents the gain when the figure eight pattern is applied. Graph 302 also illustrates that the figure eight pattern can be used to reduce noise coming from the 90 and 270-degree directions. Additional beam patterns can also be used. Furthermore, the applied pattern can be fixed or adaptive. In the case of audio beamforming based on a fixed pattern, the same pattern can be applied regardless of the frequency. However, when audio beamforming is based on an adaptive pattern, the pattern can change depending on noise direction. In some cases, the pattern can also change based on frequency. For example, the pattern can shift from sub-cardioid to cardioid as noise directions change across different frequencies. In another example, the pattern can shift from a first weighted cardioid to a second weighted cardioid.

After receiving a signal from each active microphone, the processor can combine the signals to generate a single output with reduced background noise. In some cases, the signals can have an adaptive and/or fixed beam pattern applied. Furthermore, a number of different beam patterns can be applied.

Having disclosed an introductory description of how an audio signal can be processed using audio beamforming, the disclosure now returns to a discussion of selecting properties of an audio beamforming algorithm based on one or more attribute values of a computing device. A possible limitation of audio beamforming technology can be that while audio beamforming can be adaptive, in the sense that as the frequency changes different beam patterns can be applied, audio beamforming does not account for variations within the environment of the computing device. This can lead to sub-optimal noise reduction results. That is, directional noise reduction results can be improved by incorporating additional computing environmental characteristics. For example, audio beamforming based on adaptive patterns can yield audio results with artifacts that may be perceivable to the human ear, but the produced audio data may be well suited for automated speech recognition.

To address this limitation and produce improved noise reduction results, an audio beamformer can be dynamically adjusted so that it adapts to the current state of the computing device. The audio beamformer can be configured to load an adaptive or fixed mode and/or to load different pre-defined spatial response patterns. These configuration options can be based on an active application and/or system state. For example, if it is known that the input signal will be used by a speech recognition application, the audio beamforming algorithm can use an adaptive pattern. In another example, if it is known that the input signal will be used by an application that facilitates audio and/or video communication between one or more users, the audio beamforming algorithm can use a fixed pattern. Furthermore, the patterns applied in either an adaptive or fixed algorithm can be selected based on additional properties of the system, such as fan speed and/or current audio route, e.g. headphones, built-in speakers, etc. Additional system properties can also be leveraged such as the placement of the fan and/or speakers with respect to the microphone array.

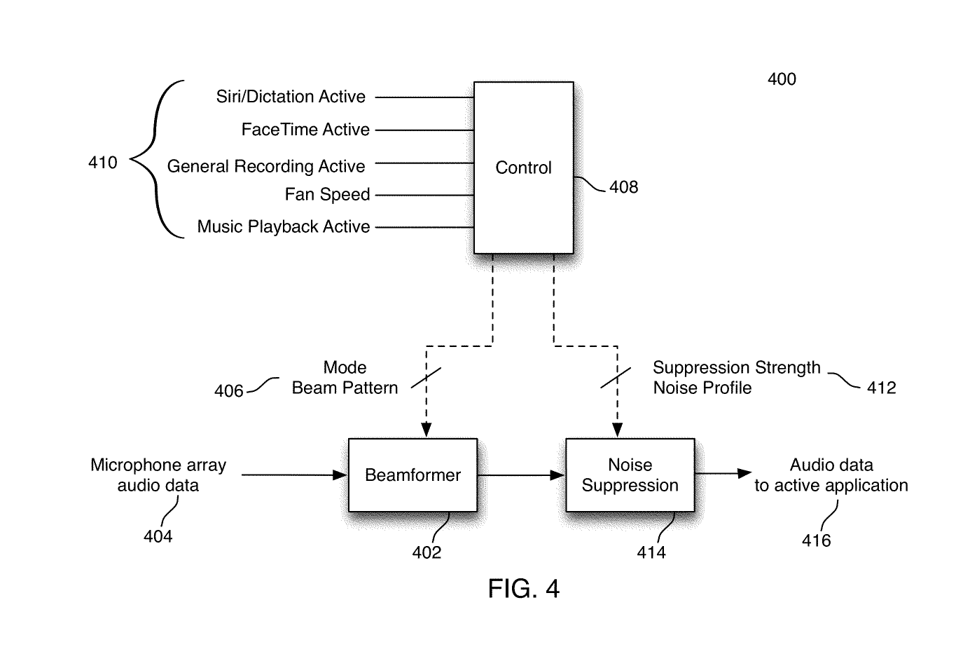

FIG. 4 illustrates an exemplary audio beamformer configuration process 400, which can occur on a computing device such as computing device 200 in FIG. 2. The computing device 200 can be running one or more applications, such as a dictation application, an audio communications application, a video chat application, an audio recording application, a music playback application, etc. In some cases, an application can be active while the other applications are running in the background and/or are suspended. Furthermore, in some cases, the active or primary application can use input audio data that can be processed using audio beamforming.

The computing system 200 can receive microphone array audio data 404, which can be supplied as an input to a beamformer 402. In response to the computing system 200 receiving microphone array audio data 404, a control module 408, within computing system 200, can detect system information 410 regarding the state of the computing system 200. In some cases, the system information 410 can indicate what application is currently active, such as a dictation application, e.g. the Siri application, published by Apple Inc. of Cupertino, Calif.; an audio and/or video communications application, e.g. the FaceTime application, published by Apple Inc.; an audio recording application; or a music playback application. Additionally, the system information 410 can include other system state, such as whether a fan is active or speed of a fan.

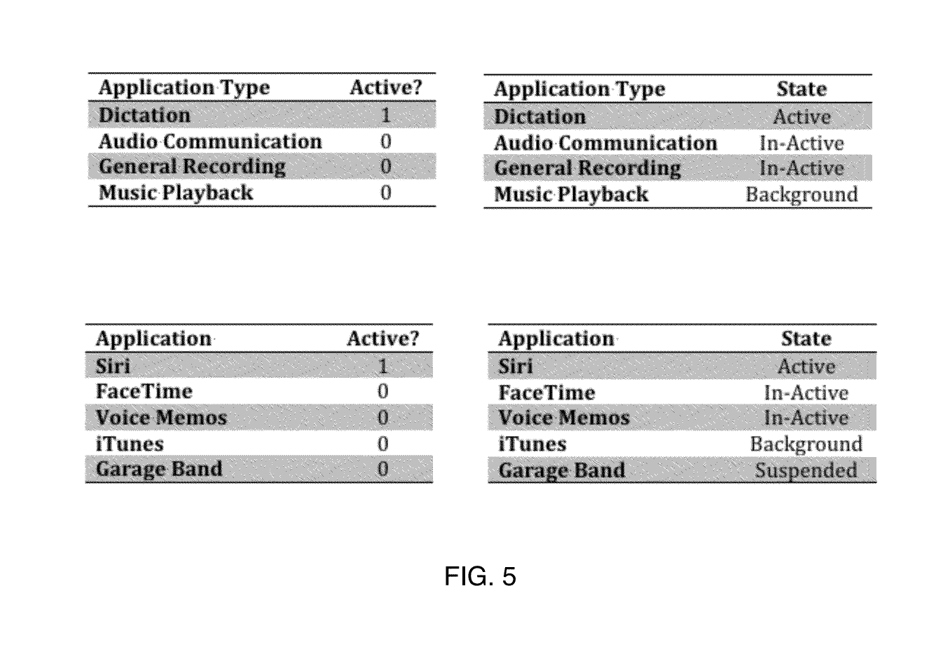

The representation of the system information 410 can vary with the configuration of the system and/or the information type. For example, the system information 410 can be represented as a table that lists application type categories and an activity level. The activity level can be a binary value indicating whether an application of the particular type is active. In some cases, the activity level can have multiple states, such as active, in-active, background, suspended, etc. In another example, the system information 410 can be represented as a table that lists application identifiers, such as the names of particular applications or some other unique identifier, and an activity level. Again the activity level can be a binary value or it can have multiple possible values. FIG. 5 illustrates four exemplary representations of system information 410 specific to the status of applications running on the computing system 200. Other representations of the system information 410 are also possible, such as a single variable for application information. The variable can be set to a unique identifier indicating a specific application or application type. Other system states can be represented using similar techniques. For example, a binary value can be used to indicate that a system fan is on or off. Alternatively, a value such as an integer can be used to indicate the fan speed.

Referring back to FIG. 4, the control module 408 can use the system information 410 to select a mode and/or pattern to be used in the beamformer 402 in processing the audio data 404. In some cases, the control module 408 can use information regarding what application type or specific application is active to select between fixed and adaptive modes. For example, the control module 408 can select fixed mode if the application type is audio communication. In another example, the control module 408 can select fully adaptive if the application type is speech recognition. In some cases, the control module 408 can additionally or alternatively use other system state, such as fan speed, in the selection of a mode.

In addition to selecting a mode, the control module 408 can use the system information 410 to optionally select a specific pattern or a sequence of patterns. For example, the control module 408 can select the cardioid pattern if the application type is audio communication. In another example, the control module 408 can select the hyper-cardioid pattern if the application type is audio communication and the computing system has a specific configuration of the microphone array and speaker placement. In yet another example, the control module 408 can select the sub-cardioid pattern if the fan is running above a predefined fan speed. Additional and/or alternative pattern selections are also possible.

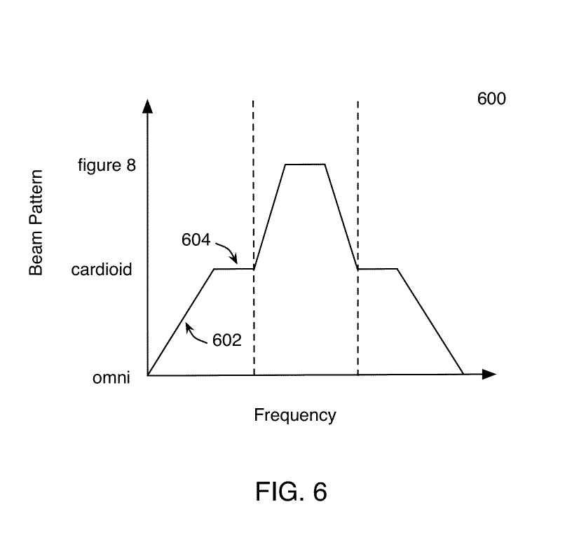

The control module 408 can also select a sequence of patterns to be used by the beamformer 402 in an adaptive mode that is a hybrid of fixed and adaptive patterns. FIG. 6 illustrates an exemplary hybrid fixed-adaptive beam pattern scenario 600. As illustrated, the beam pattern can vary between three patterns—omnidirectional, cardioid, and figure eight—as the frequency of the signal changes. In this example, each frequency band varies between two pattern types. A sloped line, such as line 602, can indicate that as the frequency increases, an adaptive mode can be used, which can vary the pattern between two patterns. For example, line 602 indicates that as the frequency increases, the pattern varies from omnidirectional to cardioid. A non-sloped line, such as line 604, can indicate that as the frequency increases, the pattern can remain fixed. For example, line 604 indicates that as the frequency increases, the fixed cardioid pattern is used. The number of patterns in the sequence for a hybrid fixed-adaptive mode can vary with the configuration of the system and/or can be based on the system information 410. Additionally, the rate of adaption and/or the frequency range for which a pattern remains fixed can vary with the system configuration and/or can be based on the system information 410.

Referring back to FIG. 4, after making a selection based on the system information 410, the control module 408 can send the mode and/or beam pattern 406 to the beamformer 402. The beamformer 402 can then process the audio data 404. After processing the audio data 404, the beamformer 402 can optionally send the processed audio data 404 to a noise suppression module 414. The control module 408 can also use the system information 410 to generate a suppression strength noise profile 412, which the control module 408 can supply to the noise suppression module 414. The noise suppression module 414 can use the suppression strength noise profile 412 to process the received audio data 404. After all processing is complete, the processed audio data 404 can be sent to the active application 416.

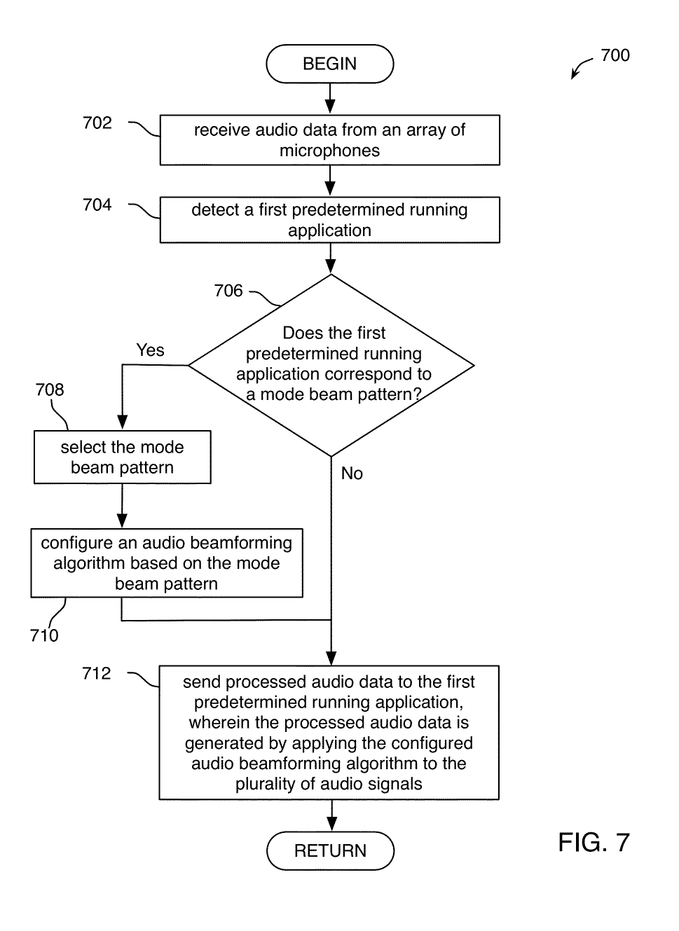

FIG. 7 is a flowchart illustrating an exemplary method 700 for configuring an audio beamforming algorithm based on system settings. For the sake of clarity, this method is discussed in terms of an exemplary system 200 such as is shown in FIG. 2. Although specific steps are shown in FIG. 7, in other embodiments a method can have more or less steps than shown. The configuration of an audio beamforming algorithm can begin when the system 200 receives audio data from a microphone array (702). After receiving the data, the system 200 can detect a first predetermined running application (704). In some cases, the first predetermined running application can be a dictation application, a speech recognition application, an audio communications application, a video chat application, or an audio recording application. In some embodiments, the system can also detect at least one predetermined device setting. The at least one predetermined device setting can be a fan speed, a current audio route, and/or a configuration of microphone and speaker placement.

The system 200 can check if the first predetermined running application, and optionally the at least one predetermined device setting, correspond to a mode beam pattern (706). If the system 200 can identify a corresponding mode beam pattern, the system 200 can select the identified mode beam pattern (708). The mode beam pattern can specify a mode, e.g. fixed or adaptive, and/or a beam pattern, e.g. omnidirectional, cardioid, hyper-cardiod, sub-cardioid, figure eight, etc. Based on the selected mode beam pattern, the system can configure an audio beamforming algorithm (710). In some cases, the configuring can cause a beamformer to load a mode and/or beam pattern specified in the mode beam pattern. In some cases, the system can have a default mode and/or pattern such that if a mode and/or pattern is not specified in the mode beam pattern or a corresponding mode beam pattern can not be found, default value(s) can be used to configure the audio beamforming algorithm. If the system 200 cannot identify a corresponding mode beam pattern, the system 200 can proceed to processing the audio data without making any configuration adjustments to the audio beamforming algorithm. Alternatively, the system 200 can configure the audio beamforming algorithm using default values.

After the audio beamforming algorithm is configured, the system can process the audio data using the configured beamforming algorithm. Furthermore, the system can send the processed data to the first predetermined running application (712). In some embodiments, prior to sending the processed audio data to the first predetermined running application, the system can apply a noise suppression algorithm to the processed audio data. Additionally, the system can use the first predetermined running application and/or the at least one predetermined device setting to generate a suppression strength noise profile. The system can use the suppression strength noise profile in the noise suppression algorithm. In some cases the suppression strength noise profile can be a noise floor. After completing step 712, the system 200 can resume previous processing, which can include repeating method 600.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer-implemented method comprising:
receiving, via an array of microphones, a plurality of audio signals;
detecting a first predetermined running application;
configuring an audio beamforming algorithm based on the detected first predetermined running application; and
sending processed audio data to the first predetermined running application, wherein the processed audio data is generated by applying the configured audio beamforming algorithm to the plurality of audio signals.

2. The computer-implemented method of claim 1, wherein configuring the audio beamforming algorithm further comprises setting a mode beam pattern based on the detected first predetermined running application, wherein the mode beam pattern is an adaptive mode.

3. The computer-implemented method of claim 1, further comprising:
detecting at least one predetermined device setting.

4. The computer- implemented method of claim 1, further comprising:
prior to sending the processed audio data to the first predetermined running application, applying a noise suppression algorithm to the processed audio data, wherein the noise suppression algorithm includes a predetermined noise floor.

5. The computer-implemented method of claim 3, wherein the first predetermined running application is a dictation application, audio communications application, video chat application, or audio recording application and wherein the predetermined device setting is fan speed above a threshold or notification of active audio output.

6. A system comprising:
a processor;
an array of microphones;
a computer-readable storage media storing instructions for controlling the processor to perform steps comprising:
configuring an audio beamforming algorithm by setting a mode beam pattern based on a detected first predetermined running application;
generating processed audio data by applying the configured audio beamforming algorithm to a plurality of audio signals received from the array of microphones; and
sending the processed audio data to the first predetermined running application.

7. The system of claim 6, the steps further comprising:
detecting at least one predetermined system setting; and
configuring the audio beamforming algorithm based on the at least one predetermined system setting.

8. The system of claim 7, wherein the at least one predetermined system setting is at least one of a fan speed, current audio route, or a configuration of the array of microphones and a speaker placement.

9. The system of claim 6, wherein the mode beam pattern can specify a mode and a beam pattern.

10. The system of claim 9, wherein the mode is an adaptive mode, a fixed mode, or a hybrid fixed-adaptive mode.

11. The system of claim 9, wherein the beam pattern is omnidirectional, cardioid, hyper-cardioid, sub-cardioid, figure eight, or a sequence thereof.

12. A non-transitory computer-readable storage media storing instructions which, when executed by a computing device, causes the computing device to perform steps comprising:
selecting a mode beam pattern based on a detected predetermined running application;
using the selected mode beam pattern to configure an audio beamforming algorithm; and
sending processed audio data to the predetermined running application, wherein the processed audio data is generated by applying the configured audio beamforming algorithm to a plurality of audio signals received from an array of microphones.

13. The non-transitory computer-readable storage media of claim 12, wherein selecting the mode beam pattern is further based on at least one detected current device setting.

14. The non-transitory computer-readable storage media of claim 13, further comprising:
prior to sending the processed audio data to the predetermined running application, applying a noise suppression algorithm to the processed audio data.

15. The non-transitory computer-readable storage media of claim 14, wherein the noise suppression algorithm is configured based on at least one of the predetermined running algorithm or the at least one detected current device setting.

16. The non-transitory computer-readable storage media of claim 12, wherein the detected predetermined running application is a dictation application, audio communications application, video chat application, or audio recording application.

17. A computer-implemented method comprising:
receiving, via an array of microphones, a plurality of audio signals;
detecting a predetermined running application and at least one predetermined device setting;
configuring an audio beamforming algorithm by setting a mode beam pattern based on the detected predetermined running application and the at least one predetermined device setting;
applying the configured audio beamforming algorithm to the plurality of audio signals to generate processed audio data; and
sending the processed audio data to the detected predetermined running application.

18. The computer-implemented method of claim 17, wherein the detected predetermined running application is a speech recognition application, and wherein the mode beam pattern specifies an adaptive mode.

19. The computer-implemented method of claim 17, wherein the detected predetermined running application is an audio communications application, and wherein the mode beam pattern specifies a fixed mode.

20. The computer-implemented method of claim 19, wherein the mode beam pattern specifies a cardioid beam pattern.
